(19) United States
(12) Patent Application Publication
(10) Pub. No.: US 2006/0244926 A1
(43) Pub. Date: Nov. 2, 2006

(54) Water-cooled projector

(75) Inventors: Fu Shiung Shih, Taichung County (TW); Shun Chieh Yang, Taipei County (TW); Chun Ming Shen, Taipei County (TW); Chang Chien Li, Taipei County (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/414,720

(22) Filed: Apr. 27, 2006

(30) Foreign Application Priority Data
Apr. 28, 2005 (TW) TW94113653

(51) Int. Cl. G03B 21/18

(52) U.S. Cl. 353/54

(57) ABSTRACT

A water-cooled projector. The water-cooled projector includes a digital micromirror device chip, a thermoelectric cooling chip, and a water-cooled radiator. The thermoelectric cooling chip includes a heat absorption surface and a heat dissipation surface. The heat absorption surface abuts the digital micromirror device chip. The heat dissipation surface abuts the water-cooled radiator.

### BACKGROUND

The invention relates to a water-cooled projector, and in particular, to a water-cooled projector with a thermoelectric cooling chip for dissipating heat.

Conventional projectors are normally cooled by air. Air cooling, however, is not adequate for a projector with higher brightness, smaller volume and lower noise Thus, various heat-dissipation methods are provided.

### SUMMARY

Water-cooled projectors are provided. An exemplary embodiment of a water-cooled projector comprises a digital micromirror device (DMD) chip, a thermoelectric cooling chip, and a water-cooled radiator. The thermoelectric cooling chip comprises a heat absorption surface and a heat dissipation surface. The heat absorption surface abuts the digital micromirror device chip. The water-cooled radiator abuts the heat dissipation surface.

Furthermore, the water-cooled projector comprises a heat exchange module, a water tank, a transportation device, and a housing. The heat exchange module is connected with the water-cooled radiator to cool water from the water-cooled radiator. The heat exchange module may comprise a condenser and a fan. The water tank is connected with the water-cooled radiator to supply water to the water-cooled radiator. The transportation device is disposed between the water tank and the water-cooled radiator to transport the water from the water tank to the water-cooled radiator. The transportation device may be a motor. The housing receives the thermoelectric cooling chip, the digital micromirror device chip, and the water-cooled radiator therein. The heat exchange module, the water tank, and the transportation device are disposed outside the housing.

Note that the thermoelectric cooling chip is disposed between the digital micromirror device chip and the water-cooled radiator.

Electronic apparatuses are provided. An exemplary embodiment of an electronic apparatus comprises a chip, a thermoelectric cooling chip, and a liquid-cooled radiator. The thermoelectric cooling chip comprises a heat absorption surface and a heat dissipation surface. The heat absorption surface abuts the chip. The liquid-cooled radiator abuts the heat dissipation surface.

Furthermore, the electronic apparatus comprises a heat exchange module, a liquid tank, and a transportation device. The heat exchange module is connected with the liquid-cooled radiator to cool liquid from the liquid-cooled radiator. The liquid tank is connected with the liquid-cooled radiator to supply liquid to the liquid-cooled radiator. The transportation device is disposed between the liquid tank and the liquid-cooled radiator to transport the liquid from the liquid tank to the liquid-cooled radiator.

### DESCRIPTION OF THE DRAWINGS

The invention can be more fully understood by reading the subsequent detailed description and examples with references made to the accompanying drawings, wherein:

FIG. 1 is a schematic view of an embodiment of a water-cooled projector.

### DETAILED DESCRIPTION

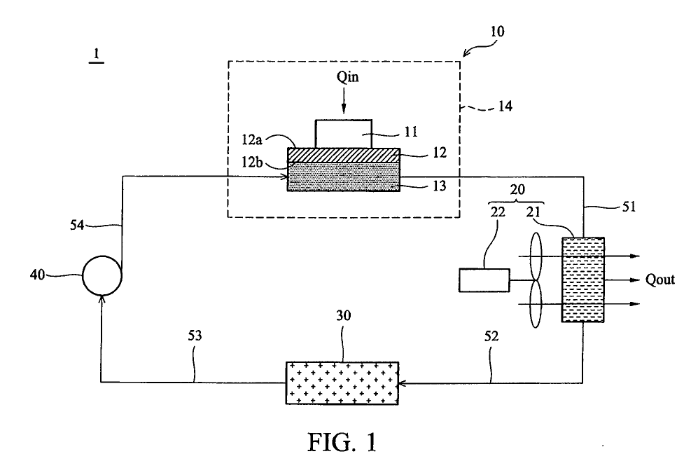

Referring to FIG. 1, an embodiment of a water-cooled projector 1 comprises a main body 10, a heat exchange module 20, a water tank 30, and a transportation device 40. The main body 10 comprises a digital micromirror device chip 11, a thermoelectric cooling chip 12, and a water-cooled radiator 13, and a housing 14. Note that since other components in the main body 10 are less related with this invention, they are not shown in the figure.

The digital micromirror device chip 11 increases contrast of images. The thermoelectric cooling chip 12 comprises a heat absorption surface 12a and a heat dissipation surface 12b. The heat absorption surface 12a abuts the digital micromirror device chip 11. The water-cooled radiator 13 abuts the heat dissipation surface 12b. Although the thermoelectric cooling chip 12 is disposed between the digital micromirror device chip 11 and the water-cooled radiator 13 in FIG. 1, it is not limited to this.

The housing 14 receives the thermoelectric cooling chip 12, the digital micromirror device chip 11, and the water-cooled radiator 13 therein. The heat exchange module 20, the water tank 30, and the transportation device 40 are disposed outside the housing 14. Note that although the heat exchange module 20, the water tank 30, and the transportation device 40 are disposed outside the housing 14 in FIG. 1, they are not limited to this. For example, based on arrangement, any one, any two, or all of the heat exchange module 20, the water tank 30, and the transportation device 40 may be disposed inside the housing 14.

The heat exchange module 20 is connected with the water-cooled radiator 13 via a pipe 51 to cool water from the water-cooled radiator 13. The heat exchange module 20 comprises a condenser 21 and a fan 22 that generates air convection to cool water flowing through the condenser 21. Note that although the heat exchange module 20 comprises the condenser 21 and the fan 22 in FIG. 1, it is not limited to this.

The water tank 30 is connected with the water-cooled radiator 13 via the transportation device 40 to supply water to the water-cooled radiator 13. The water tank 30 and the heat exchange module 20 are connected via a pipe 52 so that water from the heat exchange module 20 reflows to the water tank 30.

The transportation device 40 is disposed between the water tank 30 and the water-cooled radiator 13, and is connected with the water tank 30 and the water-cooled radiator 13 via pipes 53 and 54 respectively to transport the water from the water tank 30 to the water-cooled radiator 13. The transportation device 40 may be a motor; however, it is not limited to this.

Note that although the water-cooled radiator 13, the heat exchange module 20, the water tank 30, and the transportation device 40 are connected via the pipes 51, 52, 53 and 54 in FIG. 1, they are not limited to this. The pipes may be omitted so that the water-cooled radiator 13, the heat exchange module 20, the water tank 30, and the transportation device 40 are connected directly.

In the water-cooled projector 1 in FIG. 1, heat generated by the digital micromirror device chip 11 can be directly cooled by the thermoelectric cooling chip 12, and heat generated by the thermoelectric cooling chip 12 is taken away by the water in the water-cooled radiator 13. The heated water then is cooled in the condenser 21 of the heat exchange module 20, and returns to the water tank 30. The transportation device 40 pumps the recycled water to the water-cooled radiator 13 again to complete a cycle.

As previously described, in this embodiment, the heat of the projector is dissipated via the thermoelectric cooling chip and the water. Thus, the design of this embodiment may be adapted to a projector with high brightness.

Note that the design concept of the water-cooled projector of the invention may be adapted to other electronic apparatuses requiring a thermoelectric cooling chip. Also, the water may be replaced by other liquid, such as refrigerant. At this time, the water tank is replaced by the liquid tank while the water, flowing through the radiator, the heat exchange module and the transportation device, is replaced by the liquid supplied by the liquid tank.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A water-cooled projector comprising:
a digital micromirror device chip;
a thermoelectric cooling chip comprising a heat absorption surface and a heat dissipation surface, wherein the heat absorption surface abuts the digital micromirror device chip; and
a water-cooled radiator abutting the heat dissipation surface.

2. The water-cooled projector as claimed in claim 1, further comprising a heat exchange module connected with the water-cooled radiator to cool water from the water-cooled radiator.

3. The water-cooled projector as claimed in claim 2, wherein the heat exchange module comprises a condenser.

4. The water-cooled projector as claimed in claim 3, wherein the heat exchange module further comprises a fan.

5. The water-cooled projector as claimed in claim 2, further comprising a water tank connected with the water-cooled radiator to supply water to the water-cooled radiator.

6. The water-cooled projector as claimed in claim 5, further comprising a transportation device disposed between the water tank and the water-cooled radiator to transport the water from the water tank to the water-cooled radiator.

7. The water-cooled projector as claimed in claim 6, wherein the transportation device is a motor.

8. The water-cooled projector as claimed in claim 6, further comprising a housing to receive the thermoelectric cooling chip, the digital micromirror device chip, and the water-cooled radiator therein.

9. The water-cooled projector as claimed in claim 8, wherein the heat exchange module, the water tank, and the transportation device are disposed outside the housing.

10. The water-cooled projector as claimed in claim 1, wherein the thermoelectric cooling chip is disposed between the digital micromirror device chip and the water-cooled radiator.

11. An electronic apparatus comprising:
a chip;
a thermoelectric cooling chip comprising a heat absorption surface and a heat dissipation surface, wherein the heat absorption surface abuts the chip; and
a liquid-cooled radiator abutting the heat dissipation surface.

12. The electronic apparatus as claimed in claim 11, further comprising a heat exchange module connected with the liquid-cooled radiator to cool liquid from the liquid-cooled radiator.

13. The electronic apparatus as claimed in claim 11, further comprising a liquid tank connected with the liquid-cooled radiator to supply liquid to the liquid-cooled radiator.

14. The electronic apparatus as claimed in claim 13, further comprising a transportation device disposed between the liquid tank and the liquid-cooled radiator to transport the liquid from the liquid tank to the liquid-cooled radiator.
